(19) United States
(12) Patent Application Publication
(10) Pub. No.: US 2021/0073974 A1
(43) Pub. Date: Mar. 11, 2021

(54) Device for printing containers and method for inspecting containers in a printing device

(71) Applicant: KHS GmbH, Dortmund (DE)

(72) Inventors: Sascha Koers, Bergkamen (DE); Holger Stenner, Haltern Am See (DE)

(73) Assignee: KHS GmbH, Dortmund (DE)

(21) Appl. No.: 16/965,431

(22) PCT Filed: Jan. 22, 2019
(86) PCT No.: PCT/EP2019/051469

§ 371 Date: Jul. 28, 2020

(30) Foreign Application Priority Data
Mar. 7, 2018 (DE) 10 2018 105 202.2

(51) Int. Cl. G06T 7/00; G06K 15/02; G06K 15/00; B41J 3/407; B41J 11/00

(52) U.S. Cl. CPC G06T 7/0004; G06K 15/021; G06T 2207/30144; B41J 3/40733; B41J 11/0095; G06K 15/408

(57) ABSTRACT

An apparatus for printing on containers includes a transporter transports containers that are to be printed upon along a transport track to a container inlet of a printing station. An inspector inspects containers upstream of where transfer of the containers to the container inlet occurs. The inspector includes a light and camera that face each other. The light illuminates a first side of a container and the camera views an opposed second side thereof. Illumination of the first side scatters light from the container, thereby rendering its material distribution visible to the camera. The camera collects data that represents this distribution as different brightness values or gray scale values. A controller uses this data to identify a defective container, the defective container having brightness values or gray scale values that differ from standard values thereof.

### RELATED APPLICATIONS

This is the national stage of international application PCT/EP2019/051469, filed on Jan. 22, 2019, which claims the benefit of the Mar. 7, 2018 priority date of German application 102018105202.2, the content of which is incorporated herein by reference.

### FIELD OF INVENTION

The invention relates to a device for printing containers.

### BACKGROUND

Printing machines receive containers that are to be printed upon. In some cases, these containers are damaged or deformed. This can cause difficulties at the printing machine. In some cases, deformed or damaged containers can inflict damage on components of the printing machine itself.

### SUMMARY

An object of the present invention is that of providing an improved and economical device for printing on containers in such a way as to avoid damage to the individual printing stations, in particular to their printing heads, due to attempts to print on deformed and/or damaged containers.

The present invention relates to an apparatus for printing on containers. The device comprises a transporter for transporting the containers along a transport path to a container inlet of a printing station and an inspector associated with the transporter. The inspection is upstream of where transfer of the containers to the container inlet occurs.

The inspector comprises, along one axis, a lighting unit, provided on a first side of the container, for illuminating a container that is to be inspected, and a camera provided opposite the lighting unit on a second side of the container.

The camera captures brightness/gray scale values that indicate a characteristic material distribution that has been rendered visible by light scattered from the container's base.

The apparatus also includes a control-and-evaluation unit, or “controller,” that is connected to the inspector. The control-and-evaluation unit evaluates the extent to which a gray scale or brightness value differs from a standard value derived from the characteristic material distribution of the container base, as captured by the camera.

Some embodiments include a first removal unit upstream of the printing station's container inlet. This permits removal of containers that have a brightness/gray scale value that deviates from the standard value. Such containers therefore never enter the printing station. As a result, no more deformed containers. These deviations result from containers having been incorrectly stretched during manufacture or having been damaged. Removal of such containers prevents damage to the printing station and, in particular, to the expensive printing heads.

Other embodiments features a second removal unit is provided at the printing station's container outlet. This second removal unit removes any containers with a brightness/gray scale value that deviate from the standard value after the containers have run through the printing station.

In other embodiments, detection of a container with a brightness/gray scale value that deviates from the standard value causes a printing unit or a printing head that was responsible for printing on that container to be rendered inactive.

In some embodiments, the first and/or second removal unit is a lock-type unit. Among these are embodiments in which the lock unit is configured in a manner similar to a railway switch points.

In some embodiments, the controller comprises a memory storage unit for storing the characteristic material distribution of the container base captured by the inspector's camera.

In other embodiments, the inspector's camera is secured to a container receiver of the transporter.

In yet other embodiments, the transporter's container receiver holds a container at its neck. Among these are those in which it holds the container at a flange or neck ring. In either case, the container receiver suspends the containers during transport thereof so that their bases are clear of any surface.

In still other embodiments, the transporter is configured in a linear or circular running format. Among these are embodiments in which the transporter is an inlet star.

In some embodiments, the containers are bottles or similar packing containers.

In some embodiments, the various components are configured to be retrofitted into existing devices. These retrofittable components include the inspector and the control-and-evaluation unit connected to the inspector as well as other components that interact with the inspector, such as the removal units.

The present invention likewise relates to a method for inspecting containers in a printing device. With the method according to the invention for inspecting containers in a printing device, the containers are transported by means of a transporter along a transport track to a container inlet of a printing station in such a way that, upstream of the transfer of the containers to the container inlet, the containers are monitored by an inspector allocated to the transporter, and making use of the lighting unit provided along an axis on a first side of the container, and of a camera provided opposite the lighting unit, on a second side of the container.

In this situation, the method according to the invention comprises generating a light reflection onto the container that is to be inspected by means of the lighting unit; capturing a characteristic material distribution, rendered visible by the generated light reflection, for the corresponding container in the region of its container base, by means of different brightness values/gray scale values, with the camera; and
evaluating a gray scale/brightness value that deviates from a standard value, on the basis of the characteristic material distribution of the container base captured by the camera, by means of a control and evaluation unit connected to the inspector.

A first preferred embodiment of the method according to the invention makes provision that, by the camera, the container base is captured in the transmitted light process. In particular, in this situation the camera of the inspector looks through a mouth opening on the second side of the container, onto the container base.

A further preferred embodiment of the method according to the invention makes provision that a memory storage unit is allocated to the control and evaluation unit, for storing the characteristic material distribution of the container base captured by the camera of the inspector.

A further preferred embodiment of the method according to the invention makes provision that the characteristic material distribution of the container base captured by the camera is stored in the memory storage unit on the basis of at least one image of the container base.

A further preferred embodiment of the method according to the invention makes provision that the standard value of gray scale/brightness values of the characteristic material distribution of the container base is formed by a plurality of stored images of container bases.

A further preferred embodiment of the method according to the invention makes provision that, upstream of the container inlet of the printing station, by means of a first removal unit, those containers that exhibit a gray scale/brightness value that deviates from a standard value are removed upstream of the transfer to the printing station.

A further preferred embodiment of the method according to the invention makes provision that, in the region of the container outlet of the printing station, by means of a second removal unit, those containers that exhibit a gray scale/brightness value that deviates from a standard value are removed after running through the printing station.

A further preferred embodiment of the method according to the invention makes provision that, with a container with a gray scale/brightness value deviating from a standard value, a printing unit allocated to the container and/or a printing head allocated to the container is switched off in the printing station.

A further preferred embodiment of the method according to the invention makes provision that a container is transported suspended in a container receiver of the transporter along a transport track.

In consequence, according to the invention, a device is provided for the printing of containers, and a method for inspecting containers in a printing station, which on the one hand monitor the maintaining of the shape and/or dimensions of containers before the actual printing, in a rapid and simple manner, and act accordingly before deformed and/or damaged containers are transported into the printing station. This is done in a rapid and simple manner due to the fact that the inspection device does not seek to view at what point the container does not correspond to the desired shape, but, rather, that in comparison with other images a difference in brightness can be rapidly and easily identified, such as, for example, if a PET bottle has not been correctly stretched into position. In that case, the entire PET material is present at one point (very dark in the image), or very much less at another point (very light in the image, almost white). With a black/white inspection, therefore, this becomes evident due to a lighter or white region. By means of this simple and rapid recognition of a gross defect, the surplus stretching force can be used for a simple feature comparison, in order to identify minor defects. Accordingly, a substantial advantage is that, by means of the invention, deformed (not correctly stretched) and/or damaged containers can be identified very much more rapidly, since it is no longer necessary to have an individual procedure to monitor the container base exactly, for example, which in the past has caused problems in practice when containers of different lengths are involved, thereby incurring additional costs for special lenses. Put crudely, by means of the camera of the inspector, the container is looked at from above, through the mouth opening of the container, so as to spot whether the container base is white. If this is the case, the container is deformed or damaged, and is therefore not printed upon. This results in a further advantage. The invention thus reduces the likelihood of damage or destruction of expensive components of the printing station.

Further embodiments, advantages, and possible applications of the invention are also derived from the following description of exemplary embodiments and from the figures. In this situation, all the features described and/or represented in images are in principle the object of the invention, taken alone or in any desired combination, regardless of their combination in the claims or reference to them. The contents of the claims are also deemed to be a constituent part of the description.

### DESCRIPTION OF THE DRAWINGS

The invention is explained in greater detail hereinafter on the basis of the figures and relating to exemplary embodiments. The figures show:

FIG. 1 shows an apparatus for printing on containers.

FIG. 2 shows details of an inspector associated with the apparatus of FIG. 1;

FIG. 3 is a perspective view of an inspector associated with the apparatus shown in FIGS. 1 and 2;

FIGS. 4-6 show embodiments having one or more base bodies with cut-out openings for accommodating one or more components.

Identical reference numbers are used in the Figures for elements of the invention which are the same or have the same effect. Moreover, for easier overview, only reference numbers are represented in the individual Figures which are required for the description of the respective Figure.

### DETAILED DESCRIPTION

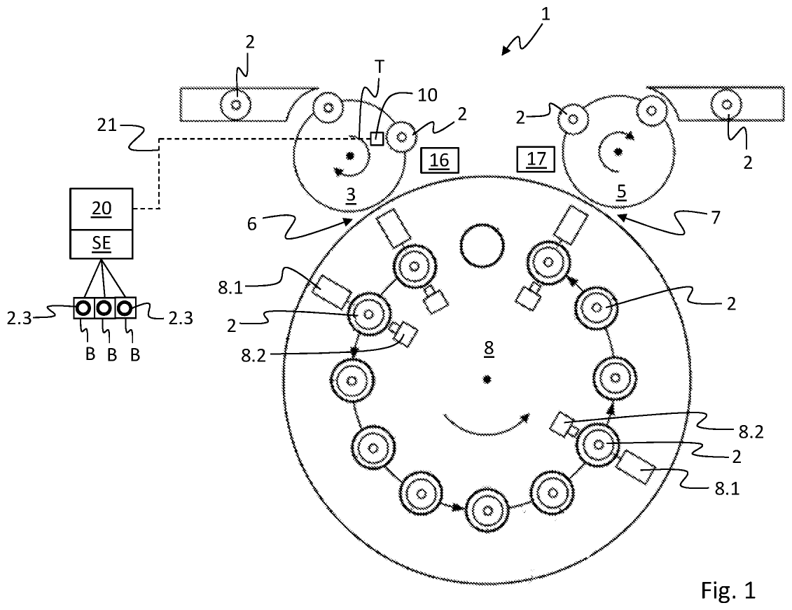

FIG. 1 shows a view from above onto a device 1 for the printing on containers 2, such as bottles, and in particular, PET bottles.

The device 1 includes first and second transporters 3, 5 that are upstream and downstream, respectively, of at least one printing station 8 having a container inlet 6 and a container outlet 7. The first transporter 3 transports the containers 2 along a transport track T to the container inlet 6 of the printing station 8. The second transporter 5 receives containers 2 from the container outlet 7.

The printing station 8 includes at least one printing unit 8.1 having at least one printing head 8.2. Each printing unit 8.1 is an ink-jet printer that prints directly on a container 2.

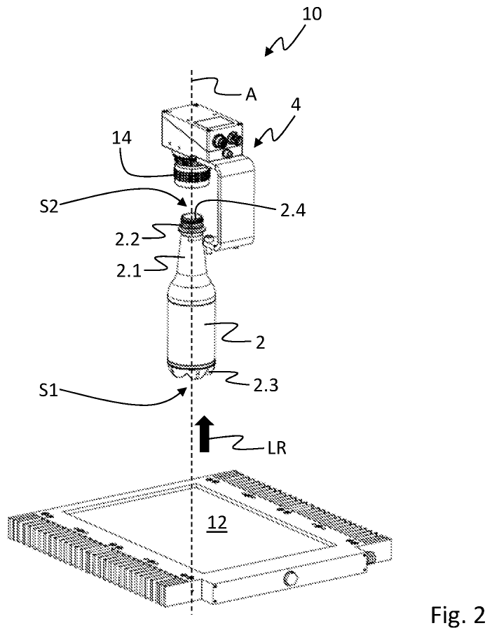

The first transporter 3 includes an inspector 10 disposed upstream of where containers 2 are transferred into the container inlet 6, details of which are shown in FIG. 2.

Referring now to FIG. 2, the inspector 10 comprises a light 12 and a camera 14. The light shines light LR along an axis A and illuminates a first side S1 of a container 2 that is to be inspected. The camera 14 lies opposite the light 12 facing a second side S2 of the container 2. In the illustrated embodiment, the first side S1 is on the container's base 2.3 and the second side S1 is at the container's mouth 2.4. In this configuration, the camera 14 captures brightness and gray-scale values that are indicative of a characteristic material distribution.

Also shown in FIG. 2 is a container receiver 4 of the first transporter 3. The container receiver 4 secures both the camera 4 and the container 2. In a preferred embodiment, the container receiver 4 secures the container at its container neck 2.1 or at a flange or neck ring 2.2. This results in the containers 2 being suspended as they are transporter.

Referring back to FIG. 1, the inspector 10 connects to a controller 20 that both controls the inspector 10 and evaluates data provided by the inspector 10. In doing so, the controller 20 determines whether the gray-scale or brightness values deviate from a standard. In some embodiments, the controller 20 is remote from the inspector 10 and connects to it using either a wired or wireless communication link. In other embodiments, the controller 20 is integral with the inspector 10.

The controller 20 includes an associated memory SE for storing a characteristic material distribution of the container base 2.3. This can be derived by saved images B of the container base 2.3. The standard value is likewise stored in the memory SE and serves as a reference image.

The device 1 further includes first and second removal units 16, 17.

The first removal unit 16, which lies just upstream of the container inlet 6, removes containers 2 that have failed inspection by the inspector 10. Such containers 2 have gray scale and brightness values that deviate excessively from the standard value.

The second removal unit 17, which lies downstream of the printing station 8, also removes containers 2 that have gray scale and brightness values that deviate excessively from the standard value. In addition, the printing unit 8.1 and/or printing heads 8.2 responsible for printing on that container 2 is switched off.

As a result of the foregoing configuration, it is possible for containers 2 to be checked for correctness of shape and/or dimensions rapidly and easily before the actual printing thereon. As a result, container that have been deformed, for example by not being correctly stretched, and containers that have otherwise been damaged, are barred from entering the printing station 8 and printing units 8.1 that have proven troublesome are barred from printing on containers 2.

The camera's field-of-view encompasses the mouth 2.4 and is thus able to inspect the distribution of gray scale or brightness values over the entire container base 2.3. A white container base 2.3 on an image B is a telltale sign of deformation or damage. Such a container 2 is therefore excluded from the printing station 8. This avoids damage or destruction of various components of the printing station 8. This results in lower maintenance cost.

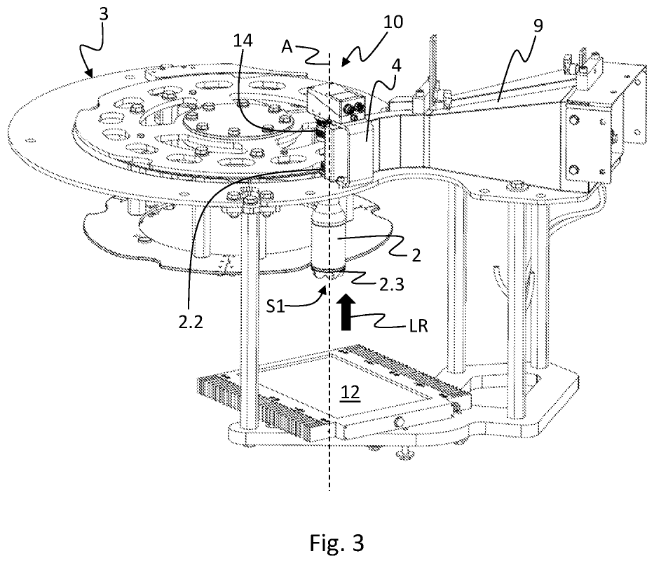

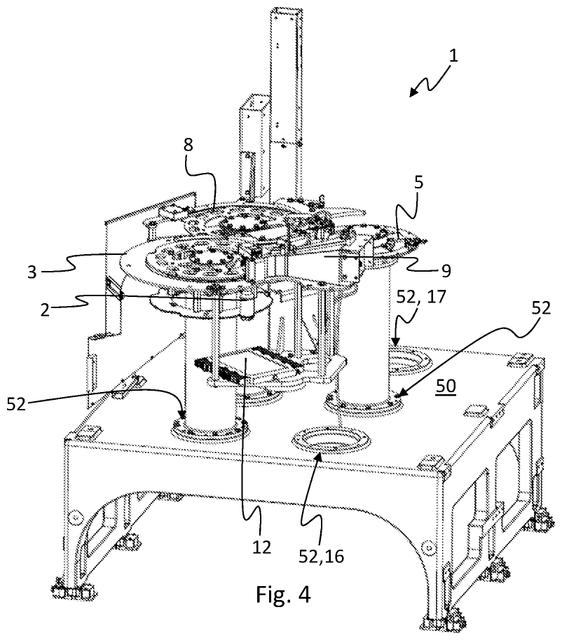

FIG. 3 shows a perspective view of the inspector 10 allocated to the first transporter 3, according to FIGS. 1 and 2. As is apparent, the inspector 10 is secured to a carrying-and-holding device 9 having one of many possible forms. As a result, it is a simple matter to retrofit existing printing stations 8 to include an inspector 10. The embodiment shown in FIG. 4 shows a modular base 50 having cut-out openings 52. In this embodiment, the various components, namely the first and second transporters 3, 5 and the printing station 8 are secured at corresponding cut-out openings 52. In some embodiments, the container inlet 16 and the container outlet 17 are likewise secured to corresponding cut-out openings 52.

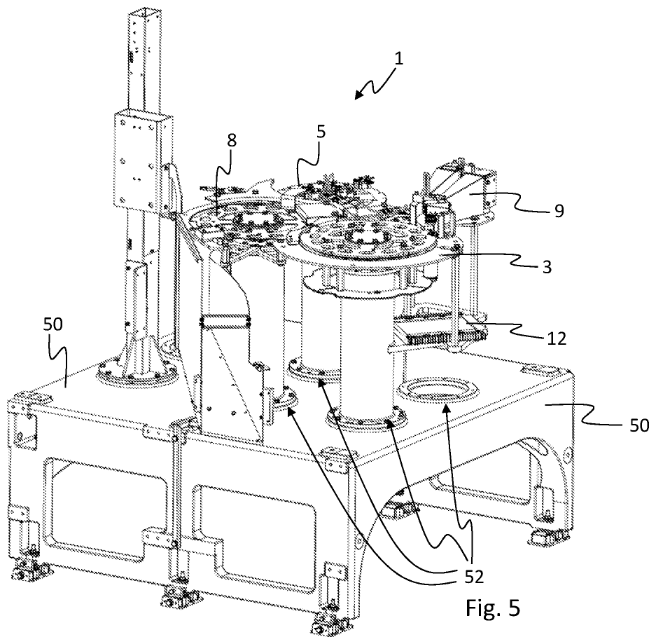

FIG. 5 shows an embodiment similar to that shown in FIG. 4 but with two modular base bodies 50.

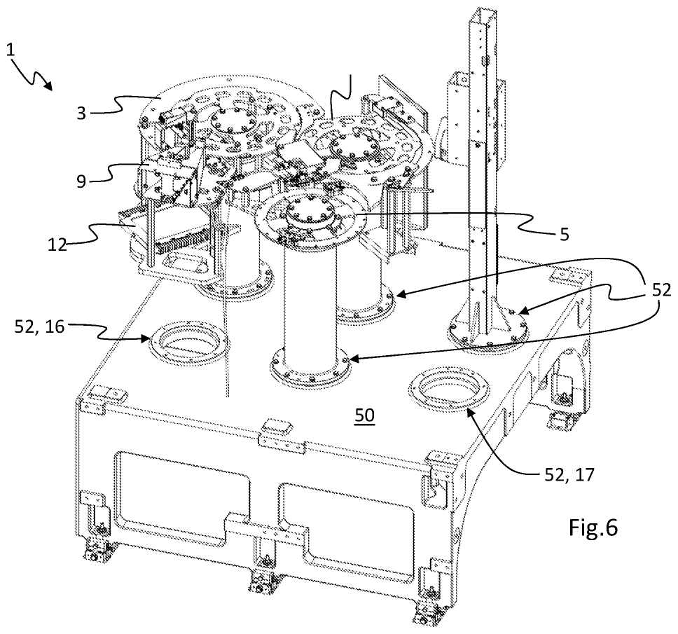

FIG. 6 shows a further embodiment in which only the first transporter 3, the printing station 8, and the second transporter 5 are arranged in other cut-out openings 52 of the modular base body 50.

As a result, no limits are set for the invention as far as the arrangement of the individual components 1 on one or more modular base bodies 50 is concerned.

The invention has been described heretofore on the basis of exemplary embodiments. It is understood that a large number of modifications or derivations are possible without thereby departing from the scope of protection of the invention as defined by the claims.

1-20. (canceled)

21. An apparatus for printing on containers, said apparatus comprising a transporter, a controller, and an inspector, wherein said inspector comprises a camera and a light, wherein said transporter transports containers that are to be printed upon along a transport track to a container inlet of a printing station, wherein said inspector is allocated to said transporter and disposed to inspect containers upstream of where transfer of said containers to said container inlet occurs, wherein said light and said camera are disposed along an axis of said inspector facing each other such that said light illuminates a first side of a container and said camera is disposed to view a second side of said container that is opposite said first side, wherein illumination of said first side causes light to be scattered from said container, thereby rendering a characteristic material distribution of said container to be visible to said camera and enabling said camera to collect data that represents said characteristic material distribution using different brightness values or gray scale values, and wherein said controller, which receives data from said inspector, is configured to identify a defective container, said defective container having brightness values or gray scale values that differ from standard values thereof.

22. The apparatus of claim 21, further comprising an upstream removal unit that is disposed upstream of said container inlet, wherein said defective container is defective prior to entering said printing station and wherein, in response to instructions from said controller, said first removal unit removes said defective container, thereby preventing said defective container from entering said printing station.

23. The apparatus of claim 21, further comprising a downstream removal unit that is disposed downstream of a container outlet of said printing station, wherein said defective container is discovered to be defective after said container has passed through said printing station, wherein, in response to instructions from said controller, said downstream removal unit removes said defective container from a container flow downstream of said printing station.

24. The apparatus of claim 21, wherein said defective container is found to be defective after having been printed upon in said printing station, wherein inspector is configured to identify a device that was used for printing upon said defective container and to render said device inactive, wherein said device is selected from the group consisting of a printing unit and a printing head.

25. The apparatus of claim 21, further comprising a removal unit disposed to intercept a defective container, wherein said removal unit is a lock-type unit.

26. The apparatus of claim 21, wherein said controller further comprises a memory in which is stored a characteristic material distribution of a base of said container as captured by said camera.

27. The apparatus of claim 21, wherein said transporter comprises a container receiver that secures said camera.

28. The apparatus of claim 21, wherein said transporter comprises a container receiver that is configured to hold containers at a location selected from the group consisting of a container neck, a neck ring, and a flange of said container.

29. The apparatus of claim 21, wherein said transporter is configured to transport containers along a linear path.

30. The apparatus of claim 21, wherein said transporter is configured to transport containers along a circular path.

31. A method comprising identifying a defective plastic container that is being transported by a transporter toward an inlet of a printing machine, said method comprising, causing said container to enter an inspector that is allocated to said transporter and disposed to inspect containers upstream of said inlet, wherein said inspector comprises a light and camera that are disposed along an axis of said inspector facing each other such that said light illuminates a first side of a container being inspected and said camera is disposed to view a second side of said container being inspected, said second side being opposite said first side, using said light to illuminate said first side, thereby causing light scattered from said container to render visible to said camera a characteristic material distribution of said container, using said camera, collecting data that represents said characteristic material distribution, said data comprising brightness values or gray scale values, causing a controller connected to said inspector to receive said data, and causing said controller to identify a defective container, said defective container having brightness values or gray scale values that differ from standard values thereof.

32. The method of claim 31, further comprising causing said camera to collect light scattered from said container's base.

33. The method of claim 31, further comprising storing said characteristic material distribution of said container base as captured by said camera in a memory connected to said controller.

34. The method of claim 31, further comprising storing images of said container base in a memory connected to said controller.

35. The method of claim 31, further comprising defining said standard values using stored images of container bases.

36. The method of claim 31, further comprising using a removal unit to remove said defective container, thereby preventing said defective container from entering said printing station.

37. The method of claim 31, further comprising identifying a container as defective after said container has passed through said printing station and removing said container from a container flow downstream of said printing station.

38. The method of claim 31, further comprising identifying a container as defective after said container has passed through said printing station, identifying a device used to print on said container, and disabling said device, wherein said device is selected from the group consisting of a printing unit and a print head.

39. The method of claim 31, further comprising suspending said container while transporting said container along a transport track towards said printing station.

40. The method of claim 31, further comprising obtaining reference values of a position and symmetry of a base seam of said container and using said reference values to identify said defective container.
